(19) United States
(12) Patent Application Publication
(10) Pub. No.: US 2025/0156609 A1
(43) Pub. Date: May 15, 2025

(54) SERVER FOR MANAGING QUALITY OF CERAMIC PRODUCT AND METHOD THEREOF

(71) Applicant: ELECTRONICS AND TELECOMMUNICATIONS RESEARCH INSTITUTE, Daejeon (KR)

(72) Inventors: Hyun Jong KIM, Daejeon (KR); Hyun Woo OH, Daejeon (KR); Seung Woog JUNG, Daejeon (KR); Su Young CHI, Daejeon (KR); Kang Il CHOI, Daejeon (KR); Yo Han CHOI, Daejeon (KR)

(21) Appl. No.: 18/944,320

(22) Filed: Nov. 12, 2024

(30) Foreign Application Priority Data
Nov. 13, 2023 (KR) 10-2023-0156682
Mar. 12, 2024 (KR) 10-2024-0034701

(51) Int. Cl. G06F 30/27; G06F 30/25; G06F 119/18

(52) U.S. Cl. CPC G06F 30/27; G06F 30/25; G06F 2119/18

(57) ABSTRACT

A server for managing quality of a ceramic product and a method thereof are provided. The server for managing quality of a ceramic product includes a memory, a communication module, and a processor connected to the memory and the communication module, in which the processor collects quality-related data including at least one of raw material composition data, process condition data, and property data, generates a training data set through correlation analysis between the raw material composition data, the process condition data, and the property data, and generates at least one of a property prediction model and a raw material composition/process condition inference model using the training data set.

### CROSS-REFERENCE TO RELATED APPLICATIONS

This application claims priority to and the benefit of Korean Patent Application No. 10-2023-0156682, filed on Nov. 13, 2023, and Korean Patent Application No. 10-2024-0034701, filed on Mar. 12, 2024, the disclosures of which are incorporated herein by reference in their entireties.

### BACKGROUND

### 1. Field of the Invention

The present invention relates to a server for managing quality of a ceramic product and a method thereof, which can manage quality (properties) of a ceramic product using artificial intelligence and infer raw material composition/process conditions for required properties.

### 2. Description of Related Art

Recently, with the expansion of future mobility markets such as electric vehicles and drones, advanced manufacturing industries such as related semiconductors, secondary batteries, and displays have grown. As a result, ceramic parts are essential in detailed processes. Due to the change in industrial structure, application fields of fine ceramics have become very important in modern life, and are largely divided into four types, electrical/electronic ceramics, living/environmental ceramics, mechanical/structural ceramics, and bioceramics.

In order for the domestic ceramic material industry to have global competitiveness, it is important to develop materials by exploring a method of optimally synthesizing ceramic materials with optimal properties in a short period of time. In general, in order to develop ceramic materials with new properties, after mixing various raw materials and going through several complex processes to synthesize these raw materials, the performance of the materials is checked. In this case, when synthesizing most ceramic materials, the properties of the materials change sensitively depending on the process conditions as well as the properties of the raw materials.

To solve this problem, industry/academic community/research institutes are trying various methods. In recent years, these industry/academic community/research institutes have been focusing on developing materials using artificial intelligence (AI) models (machine learning and deep learning) based on big data. Currently, AI is receiving much attention and is being actively studied in various fields. However, in the field of the material development, the use of AI for development is relatively less advanced compared to other fields. This is because there is a problem that material development researchers cannot easily use AI, i.e., there is a high entry barrier to AI. In order to train and utilize AI models, knowledge of computer languages as well as knowledge of AI models is required.

### SUMMARY OF THE INVENTION

The present invention is directed to providing a server for managing quality of a ceramic product and a method thereof, which can predict product properties (quality) using quality-related data generated in a ceramic manufacturing process and artificial intelligence (AI), and infer raw material composition (mixing ratio) and process conditions to satisfy the required properties of the product.

According to an aspect of the present invention, there is provided a server for managing quality of a ceramic product including a memory, a communication module, and a processor connected to the memory and the communication module, in which the processor collects quality-related data including at least one of raw material composition data, process condition data, and property data, generates a training data set through correlation analysis between the raw material composition data, the process condition data, and the property data, and generates at least one of a property prediction model and a raw material composition/process condition inference model using the training data set.

The processor may use the raw material composition data and the process condition data as input characteristics and the property data as output characteristics, generate a training data set through correlation analysis between the input characteristics and the output characteristics, apply the training data set to each of a plurality of machine learning models to predict property data, evaluate performance of each machine learning model based on the predicted property data, select an optimal machine learning model based on the performance of each machine learning model, and generate the selected optimal machine learning model as the property prediction model.

The processor may generate, as the training data set, input characteristics having a correlation coefficient between the input characteristics and the output characteristics that is greater than or equal to a preset value.

The processor may select an optimal machine learning model from among the plurality of machine learning models using performance evaluation metrics based on a difference between actual property data and the predicted property data.

The processor may analyze data distribution characteristics between a property item and raw material composition data and process condition data related to the property item, generate a training data set based on the data distribution characteristics, apply the training data set to each of the plurality of machine learning models to evaluate the performance of each machine learning model, select an optimal machine learning model based on the performance of each machine learning model, and generate the selected optimal machine learning model as the raw material composition/process condition inference model.

The processor may analyze the data distribution characteristics between the property item and the raw material composition data and the process condition data related to the property item using Pairplot.

When a property prediction request signal including the raw material composition data and the process condition data is received, the processor may input the raw material composition data and the process condition data to the property prediction model to predict properties for each process.

The processor may compare the predicted property with an actual property value to evaluate the performance of the property prediction model, and retrain the property prediction model when the evaluated performance is less than reference performance.

When a raw material composition/process condition inference request signal including a required property is received, the processor may input the required property to the raw material composition/process condition inference model to infer the raw material composition data and the process condition data.

The processor may compare the inferred raw material composition data and process condition data with an actual value to evaluate the performance of the raw material composition/process condition inference model, and retrain the raw material composition/process condition inference model when the evaluated performance is less than the reference performance.

According to an aspect of the present invention, there is provided a method of managing quality of a ceramic product including collecting, by a processor, quality-related data including at least one of raw material composition data, process condition data, and property data, and generating, by the processor, a training data set through correlation analysis between the raw material composition data, the process condition data, and the property data, and generating at least one of a property prediction model and a raw material composition/process condition inference model using the training data set.

In the generating of the training data set, the raw material composition data and the process condition data may be used as input characteristics, the property data may be used as output characteristics, a training data set may be generated through correlation analysis between the input characteristics and the output characteristics, the training data set may be applied to each of a plurality of machine learning models to predict property data, performance of each machine learning model may be evaluated based on the predicted property data, an optimal machine learning model may be selected based on the performance of each machine learning model, and the selected optimal machine learning model may be generated as the property prediction model.

In the generating of the training data set, the processor may generate, as the training data set, input characteristics having a correlation coefficient between the input characteristics and the output characteristics that is greater than or equal to a preset value.

In the generating of the training data set, the processor may select an optimal machine learning model from among the plurality of machine learning models using performance evaluation metrics based on a difference between actual property data and the predicted property data.

In the generating of the training data set, the processor may analyze data distribution characteristics between a property item and raw material composition data and process condition data related to the property item, generate the training data set based on the data distribution characteristics, apply the training data set to each of the plurality of machine learning models to evaluate the performance of each machine learning model, select an optimal machine learning model based on the performance of each machine learning model, and generate the selected optimal machine learning model as the raw material composition/process condition inference model.

In the generating of the training data set, the processor may analyze the data distribution characteristics between the property item and the raw material composition data and the process condition data related to the property item using Pairplot.

The method may further include, after the generating of the training data set, when a property prediction request signal including the raw material composition data and the process condition data is received, inputting, by the processor, the raw material composition data and the process condition data to the property prediction model to predict properties for each process.

The method may further include, after the predicting of the properties for each process, comparing the predicted property with an actual property value to evaluate the performance of the property prediction model, and retraining the property prediction model when the evaluated performance is less than reference performance.

The method may further include, after the generating of the training data set, when a raw material composition/process condition inference request signal including a required property is received, inputting, by the processor, the required property to the raw material composition/process condition inference model to infer the raw material composition data and the process condition data.

The method may further include, after inferring the raw material composition data and the process condition data, comparing, by the processor, the inferred raw material composition data and process condition data with an actual value to evaluate performance of the raw material composition/process condition inference model, and retraining the raw material composition/process condition inference model when the evaluated performance is less than reference performance.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a system for managing quality of a ceramic product according to an embodiment of the present invention;

FIG. 2 is a block diagram schematically illustrating a configuration of a server for managing quality of a ceramic product according to an embodiment of the present invention;

FIGS. 3A to 3D are exemplary diagrams for describing quality data for each ceramic material manufacturing process according to an embodiment of the present invention;

FIG. 4 is an exemplary diagram for describing the relationship between the raw material composition of a ceramic material and process conditions and target properties according to an embodiment of the present invention;

FIG. 5 is an exemplary diagram for describing a concept of switching input characteristics and target characteristics for ceramic material property prediction and condition inference according to an embodiment of the present invention;

FIG. 6 is an exemplary diagram for describing machine learning-based ceramic dielectric material property prediction according to an embodiment of the present invention;

FIG. 7 is an exemplary diagram for describing a training data set for generating a property prediction model according to an embodiment of the present invention;

FIG. 8 is an exemplary diagram for describing raw material composition and process condition inference of a machine learning-based ceramic dielectric material target property according to an embodiment of the present invention;

FIG. 9 is a flowchart for describing a method of managing quality of a ceramic product according to an embodiment of the present invention;

FIG. 10 is a flowchart for describing a method of generating a property prediction model according to an embodiment of the present invention; and

FIG. 11 is a flowchart for describing a method of generating a raw material composition/process condition inference model according to an embodiment of the present invention.

### DETAILED DESCRIPTION OF EXEMPLARY EMBODIMENTS

Hereinafter, embodiments of a server for managing quality of a ceramic product and a method thereof according to one embodiment of the present invention will be described.

In this process, thicknesses of lines, sizes of components, and the like illustrated in the accompanying drawings may be exaggerated for clearness of explanation and convenience. In addition, terms to be described below are defined in consideration of functions in the present invention and may be construed in different ways according to the intention of users or practice. Therefore, these terms should be defined on the basis of the content throughout the present specification.

Hereinafter, embodiments of the present invention will be described in detail with reference to the accompanying drawings so that those skilled in the art may easily practice the present invention. However, the present invention may be implemented in various different forms and is not limited to exemplary embodiments described herein. In addition, in the drawings, portions unrelated to the description will be omitted to clearly describe the present invention, and similar portions will be denoted by similar reference numerals throughout the specification.

Throughout the present specification, unless explicitly described to the contrary, “comprising” any components will be understood to mean that other elements can be included rather than excluding any other elements.

Implementations described in the present specification may be implemented in, for example, a method or process, an apparatus, a software program, a data stream, or a signal. Although discussed only in the context of a single form of implementation (e.g., discussed only as a method), implementations of the discussed features may also be implemented in other forms (e.g., an apparatus or a program). The apparatus may be implemented in suitable hardware, software, firmware, and the like. A method may be implemented in an apparatus such as a processor, which is generally a computer, a microprocessor, an integrated circuit, a processing device including a programmable logic device, or the like.

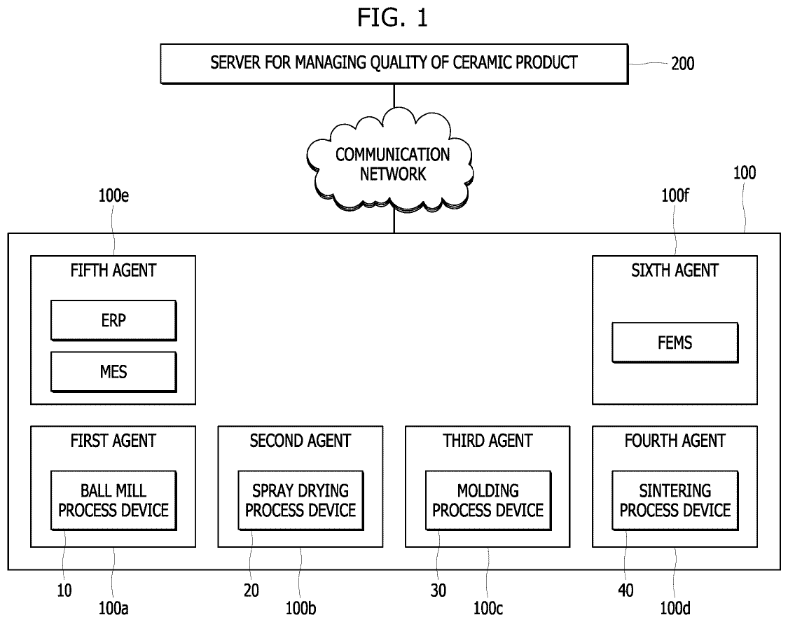

FIG. 1 is a diagram for describing a system for managing quality of a ceramic product according to an embodiment of the present invention.

Referring to FIG. 1, a system for managing quality of a ceramic product according to an embodiment of the present invention includes a plurality of agents 100 installed at a ceramic manufacturing site (factory) and a server 200 for managing quality of a ceramic product that receives quality-related data from the plurality of agents 100.

The quality-related data may include process-specific quality data, product manufacturing status data, energy usage data, etc. The ceramic manufacturing process may include a ball mill process, a spray drying process, a molding process, and a sintering process.

Therefore, the agent 100 may include a first agent 100a for collecting ball mill process quality data, a second agent 100b for collecting spray drying process quality data, a third agent 100c for collecting molding process quality data, a fourth agent 100d for collecting sintering process quality data, a fifth agent 100e for collecting product manufacturing status data, a sixth agent 100f for collecting energy usage data, etc.

The first agent 100a may collect ball mill process device status data and manufacturing environment data (e.g., temperature and humidity, vibration, pressure, etc.) from a programmable logic controller (PLC) and sensors of a ball mill process device 10.

The second agent 100b may collect spray drying process device status data and manufacturing environment data (e.g., temperature and humidity, vibration, pressure, etc.) from a PLC and sensors of a spray drying process device 20.

The third agent 100c may collect molding process device status data and manufacturing environment data (e.g., temperature and humidity, vibration, pressure, etc.) from a PLC and sensors of a molding process device 30.

The fourth agent 100d may collect sintering process device status data and manufacturing environment data (e.g., temperature and humidity, vibration, pressure, etc.) from a PLC and sensors of a sintering process device 40.

The fifth agent 100e may collect product manufacturing status data from enterprise resource planning (ERP) and a manufacturing execution system (MES) in the ceramic manufacturing factory. Here, the product manufacturing status data may include a LOT number, a production volume, etc.

The sixth agent 100f may collect energy usage data from a factory energy management system (FEMS) in the ceramic manufacturing factory.

Each agent 100 may transmit the collected data (i.e., quality-related data) to the server 200 for managing quality of a ceramic product. In this case, each agent 100 can transmit the collected data (i.e., quality-related data) to the server 200 for managing quality of a ceramic product in the form of a file such as comma-separated values (CSV) or in the form of JavaScript object notation (JSON) using representational state transfer (RESTful).

The server 200 for managing quality of a ceramic product may collect process-specific quality data from the first to fourth agents 100a, 100b, 100c, and 100d, and store and manage the collected process-specific quality data by synchronizing the collected process-specific quality data with the product manufacturing status data from the fifth agent 100e and the energy usage data from the sixth agent 100f.

The server 200 for managing quality of a ceramic product may generate a property prediction model and a raw material composition/process condition inference model using the ceramic product quality-related data collected through the agent 100.

The server 200 for managing quality of a ceramic product may predict properties of each process using the property prediction model.

The server 200 for managing quality of a ceramic product may infer raw material composition data and process condition data using the raw material composition/process condition inference model.

The server 200 for managing quality of a ceramic product may be implemented as an edge server. The server 200 for managing quality of a ceramic product may also be implemented as a cloud server.

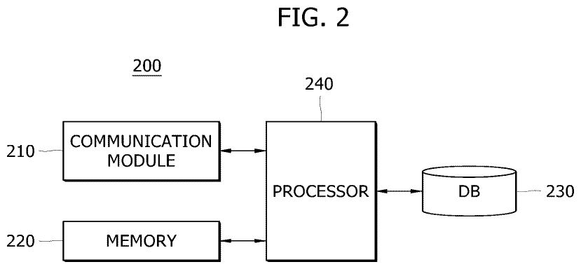

The server 200 for managing quality of a ceramic product will be described in detail with reference to FIG. 2.

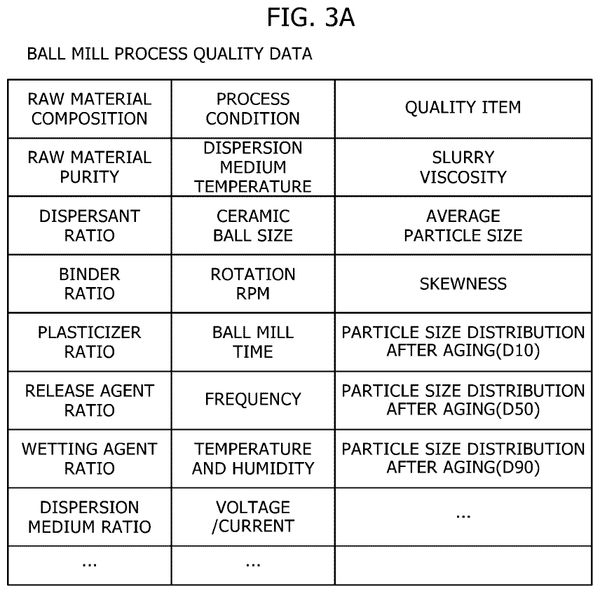

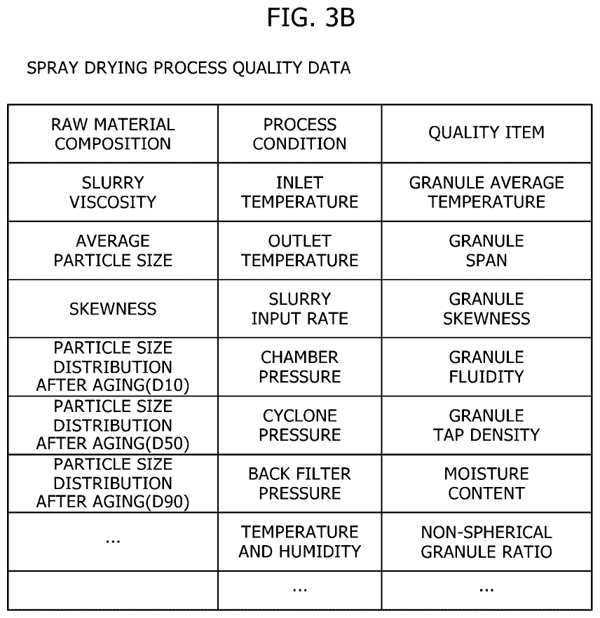

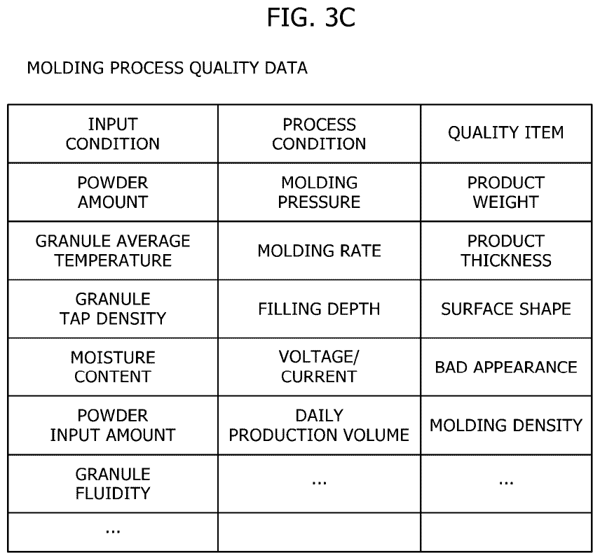

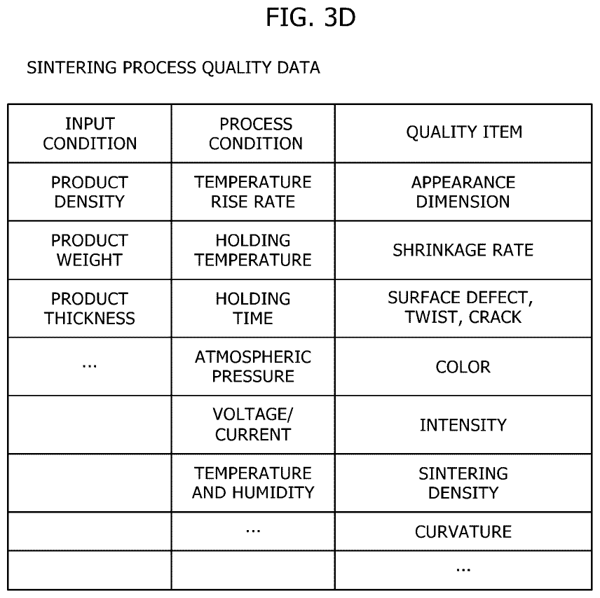

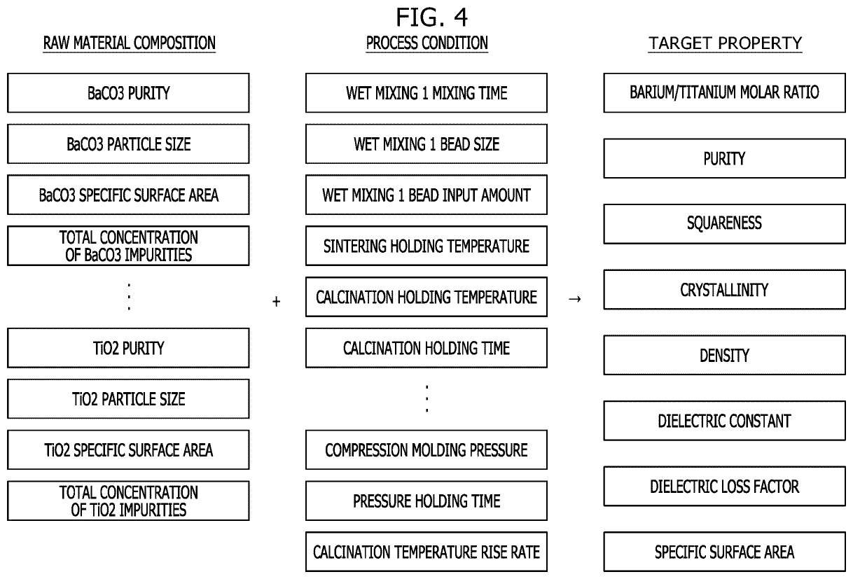

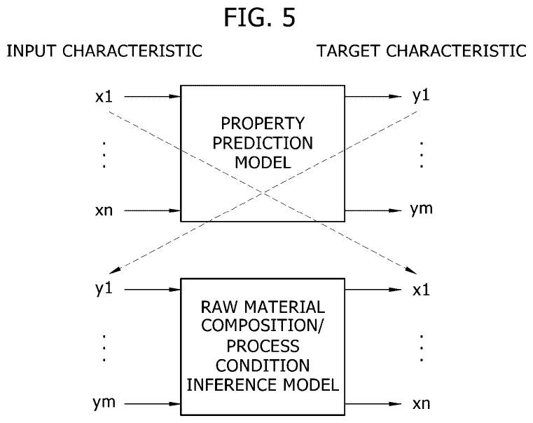

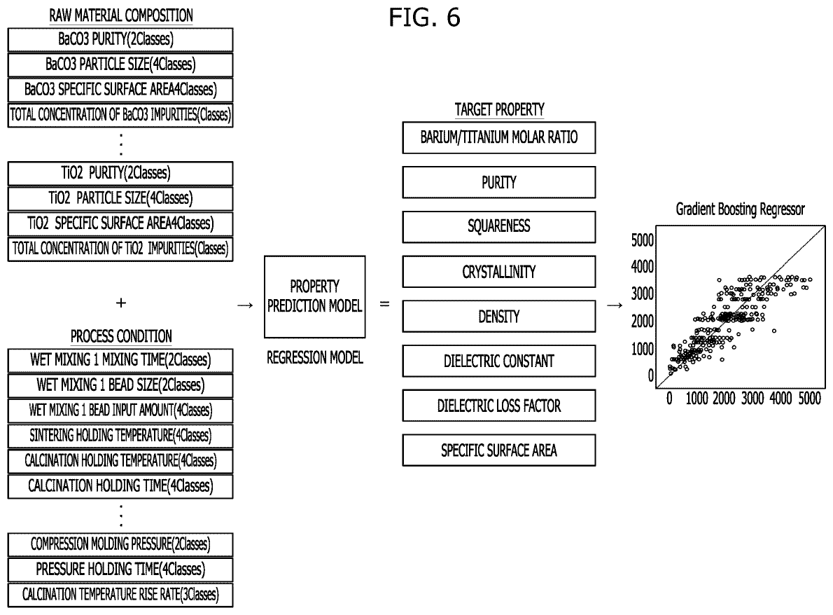

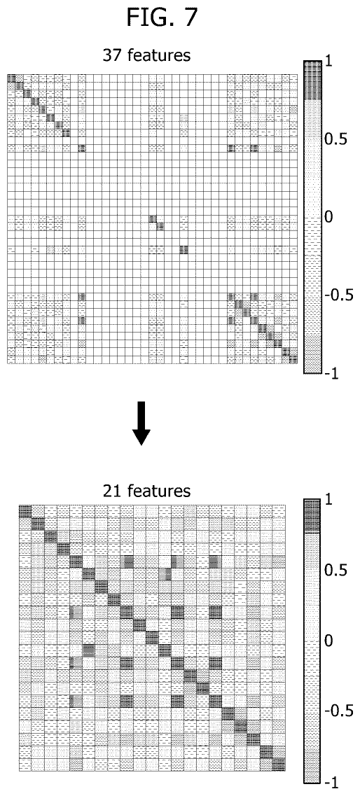

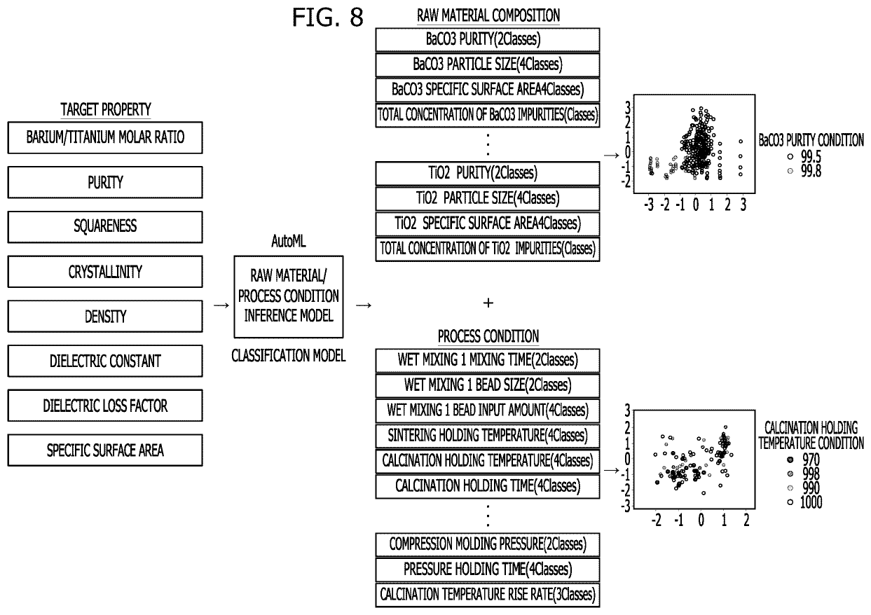

FIG. 2 is a block diagram schematically illustrating a configuration of a server for managing quality of a ceramic product according to an embodiment of the present invention, FIGS. 3A to 3D are exemplary diagrams for describing quality data for each ceramic material manufacturing process according to an embodiment of the present invention, FIG. 4 is an exemplary diagram for describing the relationship between the raw material composition of a ceramic material and process conditions and target properties according to an embodiment of the present invention, FIG. 5 is an exemplary diagram for describing a concept of switching input characteristics and target characteristics for ceramic material property prediction and condition inference according to an embodiment of the present invention, FIG. 6 is an exemplary diagram for describing machine learning-based ceramic dielectric material property prediction according to an embodiment of the present invention, FIG. 7 is an exemplary diagram for describing a training data set for generating a property prediction model according to an embodiment of the present invention, and FIG. 8 is an exemplary diagram for describing raw material composition and process condition inference of a machine learning-based ceramic dielectric material target property according to an embodiment of the present invention.

Referring to FIG. 2, the server 200 for managing quality of a ceramic product according to the embodiment of the present invention may include a communication module 210, a memory 220, a database 230, and a processor 240.

The communication module 210 may be connected to a communication network to provide a communication interface necessary to provide transmission and reception signals in the form of packet data between the server 200 for managing quality of a ceramic product and an external device (e.g., agent 100). Furthermore, the communication module 210 may receive the ceramic product quality-related data from the agent 100. In addition, the communication module 210 may be a device including hardware and software necessary to transmit and receive signals such as a control signal or a data signal through wired and wireless connections with other network devices. In addition, the communication module 210 may be implemented in various forms such as a short-range communication module, a wireless communication module, a mobile communication module, and a wired communication module.

The memory 220 is a configuration that stores data related to an operation of the server 200 for managing quality of a ceramic product. In particular, the memory 220 may store a program (application or applet) that may generate a property prediction model using the ceramic product quality-related data, a program (application or applet) that may generate a raw material composition/process condition inference model using the quality-related data of the ceramic product, a program (application or applet) that may predict properties for each process, a program (application or applet) that may infer raw material composition data and process condition data for required properties, etc., and the stored information may be optionally selected by the processor 240 as needed. In addition, the memory 220 stores various types of data generated during the execution of the operating system or program (application or applet) for driving the server 200 for managing quality of a ceramic product. In this case, the memory 220 is generally a non-volatile storage device that continues to maintain the stored information even when power is not supplied, and a volatile storage device that requires power to maintain the stored information. In addition, the memory 220 may perform a function of temporarily or permanently storing data processed by the processor 240. Here, the memory 220 may include magnetic storage media or flash storage media in addition to the volatile storage device that require power to maintain the stored information, but the scope of the present invention is not limited thereto.

The database 230 may store the ceramic product quality-related data, etc., collected through the communication module 210. Here, the quality-related data may include quality data for each ceramic manufacturing process, product manufacturing status data, energy usage data, etc.

The processor 240 may be configured to control the overall operation of the server 200 for managing quality of a ceramic product. For example, the processor 240 may execute software (e.g., a program) stored in the memory 220 to control components (e.g., at least one of the communication module 210, the memory 220, and the database 230) connected to the processor 240. The processor 240 may be implemented as, but is not limited to, an application specific integrated circuit (ASIC), a digital signal processor (DSP), programmable logic devices (PLDs), field programmable gate arrays (FPGAs), a central processing unit (CPU), microcontrollers, and/or microprocessors, etc.

The processor 240 may collect quality-related data including at least one of raw material composition data, process condition data, and property data, generate a training data set through correlation analysis between the raw material composition data, the process condition data, and the property data, and generate at least one of a property prediction model and a raw material composition/process condition inference model using the training data set.

Hereinafter, a method for the processor 240 to generate a property prediction model and a raw material composition/process condition inference model will be described.

The processor 240 may collect the ceramic product quality-related data from the agent 100 through the communication module 210 in the ceramic product manufacturing process. Here, the quality-related data may include the quality data for each ceramic manufacturing process, the product manufacturing status data, the energy usage data, etc.

Four processes (ball mill, spray drying, molding, and sintering) for ceramics are consecutive processes, and semi-finished products from each process determine the input conditions for the next process. Therefore, the processor 240 may collect the quality-related data for each process, as illustrated in FIG. 3.

The ball mill process quality data may be as illustrated in FIG. 3A. That is, the ball mill process quality data may include quality item data that includes compositions of input raw materials, a ratio of additives (binder, plasticizer, release agent, wetting agent, dispersion medium, etc.), a ceramic ball size, rotation speed, device status data such as temperature and humidity, slurry viscosity, an average particle size, particle size distribution after aging, etc.

The spray condition process quality data may be as illustrated in FIG. 3B. That is, in the spray condition process quality data, the quality item data of the ball mill process may be used as input conditions, inlet temperature, outlet temperature, a slurry input rate, chamber pressure, cyclone pressure, temperature and humidity, etc., may be used as process conditions, and a granule average particle size, a granule span, granule skewness, granule fluidity, granule tap density, moisture content, etc., may be used as the quality item data.

The molding process quality data may be as illustrated in FIG. 3C. That is, in the molding process quality data, the quality item data of the spray drying process may be used as input conditions, molding pressure, molding rate, filling depth, voltage/current, daily production volume, etc., may be used as process conditions, and a product weight, a product thickness, a surface shape, appearance defects, molding density, etc., may be used as the quality item data.

The sintering process quality data may be as illustrated in FIG. 3D. That is, in the sintering process quality data, quality item data of the molding process may be used as input conditions, a temperature rise rate, holding temperature, a holding time, atmospheric pressure, a voltage/current, temperature and humidity may be used as process conditions, and an external dimension, a shrinkage rate, surface defects, color, strength, sintering density, a curvature, etc., may be used as the quality item data.

The quality item data of each process becomes the input conditions of the next process, but when the quality item data is not input immediately, it is necessary to re-measure the items of the input conditions. Here, the quality item data may have the same meaning as the property data.

When the ceramic product quality-related data is collected, the processor 240 may generate the property prediction model and the material composition/process condition inference model using the raw material composition data, the process condition data, and the property data.

The raw material composition and process conditions and the target property of the ceramic dielectric material have the relationship as illustrated in FIG. 4. Depending on the raw material composition and process conditions, the target property measurement value exists within a certain range. These raw material composition and process conditions may be modeled as input characteristics of a machine learning-based regression model (e.g., Random Forest, Decision Tree, Gradient Boosting, AdaBoost, K-Neighbors, etc.) and the target property may be modeled as output characteristics.

Meanwhile, in order to develop new materials, it takes much time and cost to find materials having desired properties by conducting experiments with various raw material compositions and process conditions. To solve this problem, a model for predicting the target property may be trained by applying various experimental conditions as the input characteristics to an artificial intelligence regression model. Due to the characteristics of the artificial intelligence model, the input characteristics and output characteristics are linked by polynomial weights and biases. Due to these characteristics, when there is enough data collected through numerous experiments for development of ceramic materials, to reversely find the process conditions that satisfy the target property as illustrated in FIG. 5, the raw material composition and process conditions for creating the material with the target property may be explored by training the regression model through the switching of the input characteristics and target characteristics.

However, since it is not possible to conduct experiments on raw material compositions and process conditions that have infinite cases in current ceramic manufacturing sites, it is necessary to determine the raw material compositions and process conditions acquired through experience and find the conditions that satisfy the required properties within that range.

For example, as illustrated in FIG. 6, for the ceramic dielectric material property experiment, the limited raw material composition and process conditions may be used as input data, and the machine learning model with proven performance may be trained to generate the property prediction model. Since the performance of the machine learning model varies depending on the type of properties even if the same raw material composition and process conditions are used, the optimal machine learning model may be easily selected using automated machine learning (AutoML).

In order to generate the optimal property prediction model, the training data set should be generated. Accordingly, the processor 240 may generate the training data set by using the raw material composition data and the process condition data as the input characteristics and the property data as the output characteristics, and analyzing the correlation between the input characteristics and the output characteristics.

In this case, the processor 240 may generate, as the training data set, the input characteristics having a correlation coefficient between the input characteristics and the output characteristics that is greater than or equal to a preset value.

In this way, the processor 240 may perform the correlation analysis between the input characteristics of the raw material composition data and the process condition data and the output characteristics of the property data, and select the input characteristics by setting the upper and lower limits of the correlation coefficient with the output characteristics.

For example, as illustrated in FIG. 7, when a correlation coefficient of 0.3 between 37 input characteristics and 8 output characteristics is set as a constraint, 21 final input characteristics may be selected.

When the training data set is generated, the processor 240 may apply the training data set to each of the plurality of machine learning models to predict the property data. Here, the machine learning model may be the regression model. For example, the machine learning model may include multiple linear regression (MLR) analysis, deep learning, a generic algorithm (GA), boosted trees, a generative adversarial network (GAN), an artificial neural network (ANN), an ensemble, etc.

When the property data of each machine learning model is predicted, the processor 240 may evaluate the performance of each machine learning model based on the predicted property data. That is, the processor 240 may evaluate the performance of each machine learning model using performance evaluation metrics based on the difference between the property data predicted by each machine learning model and the actual property data. Here, the performance evaluation metrics may include mean absolute error (MAE), mean squared error (MSE), root mean squared error (RMSE), mean squared log error (RMSE), root mean squared log error (RMSLE), coefficient of determination (R2-Score), etc. The smaller the MAE, MSE, RMSE, MSLE, and RMSLE values, the better the regression performance, and the larger the coefficient of determination (R2-Score), the better the regression performance.

When the performance of each machine learning model is evaluated, the processor 240 may select the optimal machine learning model based on the performance of each machine learning model. In this case, the processor 240 may select the machine learning model with the best performance as the optimal machine learning model.

When the optimal machine learning model is selected, the processor 240 may repeatedly perform a process of calculating the property prediction performance by applying verification data to the optimal machine learning model, and when the property prediction performance does not satisfy the required performance, regenerating the training data set by modifying the correlation coefficient values of the input characteristics and the output characteristics.

The processor 240 may generate the optimal machine learning model as the property prediction model.

Next, the processor 240 may generate the raw material composition/process condition inference model using the raw material composition data, the process condition data, and the property data.

Switching the input/output characteristics by applying the regression model in order to infer the raw material composition and process conditions satisfying the target property is almost impossible because the data from which the experiments were conducted under a full range of conditions is required. However, in a ceramic manufacturing site, the raw material composition and process condition ranges based on experience are determined and the experiments are performed, and therefore the raw material composition and process conditions of the target property of the ceramic dielectric material may be inferred using the classification model of the machine learning as illustrated in FIG. 8. When the target property of the dielectric material is input, the conditions satisfying the corresponding property may select the optimal machine learning model by performing the AutoML on the classification model for each raw material composition and process condition.

In order to generate the optimal raw material composition/process condition inference model, the training data set should be generated. Accordingly, the processor 240 may analyze the data distribution characteristics between the property item and the raw material composition data and the process condition data related to the property item, and generate the training data set based on the data distribution characteristics. In this case, the processor 240 may analyze the data distribution characteristics between the property item and the raw material composition data and the process condition data related to the property item using Pairplot. When the data distribution characteristics are analyzed, the processor 240 may find and remove outlier data outside a specific range, thereby generating the training data set.

When the training data set is created, the processor 240 may infer the raw material composition and process condition data by applying the training data set to each of the plurality of machine learning models. Here, the machine learning model may be a classification model. For example, the machine learning model may include k-nearest neighbor (k-NN) classification, decision tree, random forest, naive Bayes, support vector machine (SVM), etc.

When the raw material composition and process condition data of each machine learning model are inferred, the processor 240 may evaluate the performance of each machine learning model based on the inferred raw material composition and process condition data. In this case, the processor 240 may evaluate the performance of each machine learning model using the accuracy of each machine learning model.

When the performance of each machine learning model is evaluated, the processor 240 may select the optimal machine learning model based on the performance of each machine learning model. In this case, the processor 240 may select the machine learning model with the best performance (accuracy) as the optimal machine learning model.

When the optimal machine learning model is selected, the processor 240 may repeatedly perform a process of calculating the inference performance by applying the verification data to the optimal machine learning model, and regenerating the training data set when the inference performance does not satisfy the required performance.

The processor 240 may generate the optimal machine learning model as the raw material composition/process condition model.

When the property prediction model and the raw material composition/process condition inference model are generated, the processor 240 may predict the properties for each process using the property prediction model, and infer the raw material composition data and the process condition data using the raw material composition/process condition inference model.

First, a method of predicting properties using a property prediction model will be described.

When the property prediction request signal including the raw material composition data and the process condition data is received (or input), the processor 240 may input the raw material composition data and the process condition data to the property prediction model to predict the properties for each process.

Specifically, a property prediction request signal including quality-related data collected in real time may be received. Here, the quality-related data may include the process-specific quality data, the product manufacturing status data, the energy usage data, etc.

When the property prediction request signal is received, the processor 240 may preprocess the quality-related data into a data format to input the quality-related data to the property prediction model.

Thereafter, the processor 240 may input the preprocessed data to the property prediction module to predict the (semi-finished) product properties (quality) for each process.

The processor 240 may visualize a process-specific quality state by synchronizing the property prediction result with the quality-related data for each process.

The processor 240 may provide the property prediction result to the user terminal (not illustrated) through the communication module 210. In addition, the processor 240 may provide the visualized process-specific quality state by synchronizing the property prediction result with the quality-related data for each process to the user terminal (not illustrated).

The processor may compare the predicted property with the actual property value to evaluate the performance of the property prediction model, and retrain the property prediction model when the evaluated performance is less than reference performance. In this case, the processor 240 may evaluate the performance of the property prediction model by using the performance evaluation metrics based on the difference between the predicted property and the actual property value.

When it is determined by comparing the predicted properties with the product quality and the experimental condition values of the actual production line that the performance is lowered to the set metrics or less, the processor 240 may retrain the property prediction model to resolve the performance degradation of the property prediction model of the manufacturing line.

To retrain the property prediction model, the processor 240 may newly collect the ceramic product quality-related data and regenerate the property prediction model using the collected quality-related data. Through this process, the server 200 for managing quality of a ceramic product may optimally manage/maintain the property prediction model for each process.

Next, the raw material composition data and process condition data for the required properties may be inferred using the raw material composition/process condition inference model.

When the raw material composition/process condition inference request signal including user requested properties is input, the processor 240 may input the user requested properties to the raw material composition/process condition inference model to infer the raw material composition data and process condition data.

When the raw material composition/process condition request signal including the user requested properties is received, the processor 240 may preprocess the requested property data into the data format for inputting the requested property data to the raw material composition/process condition inference model. Thereafter, the processor 240 may input the preprocessed data to the raw material composition/process condition inference model to infer the raw material composition data and the process condition data that satisfy the requested properties.

The processor 240 may visualize the raw material composition and process condition inference results for each requested property.

The processor 240 may provide the raw material composition and process condition inference results for each requested property to the user terminal (not shown) through the communication module 210.

The processor 240 may compare the inferred raw material composition data and process condition data with the actual value to evaluate the performance of the raw material composition/process n inference model, and retrain the raw material composition/process condition inference model when the evaluated performance is less than the reference performance. In this case, the processor 240 may evaluate the performance of each machine learning model using the accuracy of each machine learning model.

When it is determined by comparing the inferred raw material composition data and process condition data with the product quality and experimental condition values of the actual production line that the performance is lowered to the set metrics or less, the processor 240 may retrain the raw material composition/process condition inference model to resolve the degradation in the performance of the raw material composition/process condition inference model of the manufacturing line.

To retrain the raw material composition/process condition inference model, the processor 240 may newly collect the ceramic product quality-related data and regenerate the raw material composition/process condition inference model using the collected quality-related data. Through this process, the server 200 for managing quality of a ceramic product may optimally manage/maintain the raw material composition/process condition inference model of the required properties.

Meanwhile, the server 200 for managing quality of a ceramic product according to the embodiment of the present invention may further include an input module (not illustrated) and an output module (not illustrated).

The input module is provided to input user commands, etc., and may receive, for example, the raw material composition/process condition inference request signal including the required properties and transmit the received raw material composition/process condition inference request to the processor 240. The input module may be provided as a user interface such as a keyboard, mouse, a touch pad, a touch screen, an electronic pen, or a touch button.

The output module may output the property prediction result, the visualized quality status for each process shown by synchronizing the property prediction result with the quality-related data for each process, the raw material composition and process condition inference result for each required property, etc., under the control of the processor 240. This output module may be implemented as a display, a printer, etc. Here, the display may be implemented as, for example, a thin film transistor-liquid crystal display (TFT-LCD) panel, a light emitting diode (LED) panel, an organic LED (OLED) panel, an active matrix OLED (AMOLED) panel, a flexible panel, etc.

The input module and the output module may be implemented as separate configurations, or may be implemented as a single configuration, such as a touch pad or a touch screen.

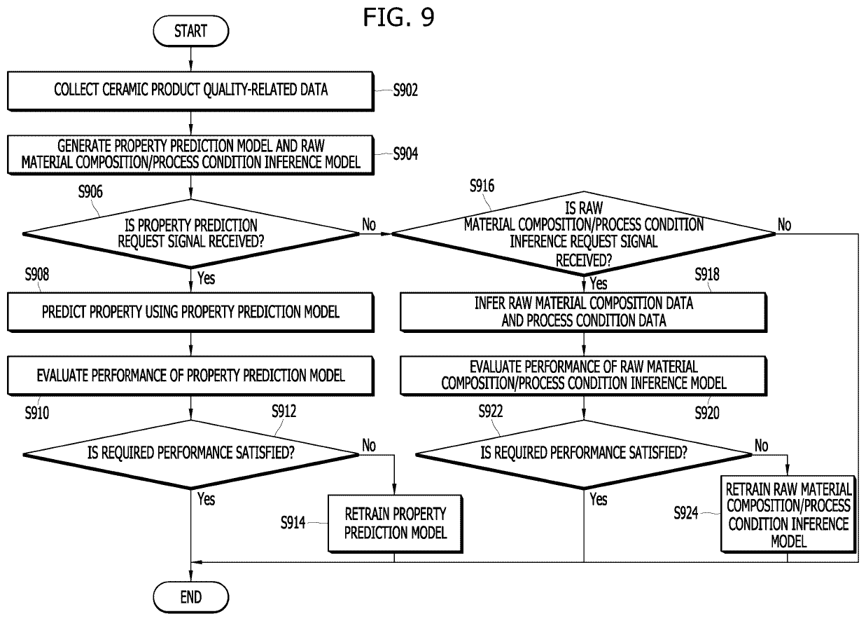

FIG. 9 is a flowchart for describing a method of managing quality of a ceramic product according to an embodiment of the present invention.

Referring to FIG. 9, the processor 240 collects the ceramic product quality-related data from the agent 100 of the ceramic manufacturing site (S902). Here, the quality-related data may include the quality data for each ceramic manufacturing process, the product manufacturing status data, the energy usage data, etc.

When operation S902 is performed, the processor 240 generates the property prediction model and the raw material composition/process condition inference model using the quality-related data (S904).

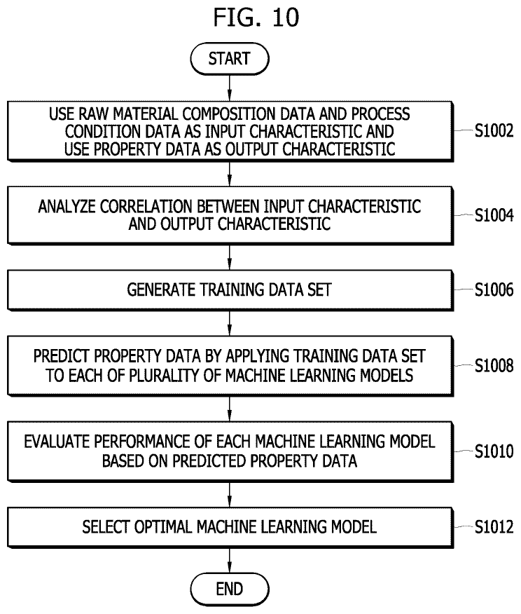

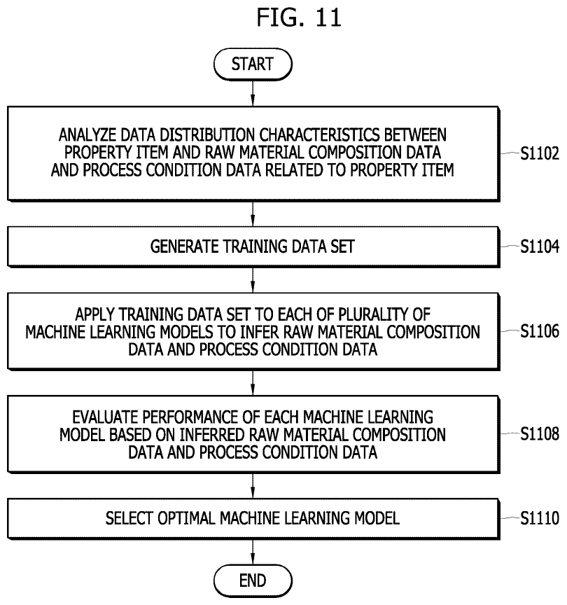

The method of generating, by the processor 240, a property prediction model will be described in detail with reference to FIG. 10. The method of generating, by the processor 240, a raw material composition/process condition inference model will be described in detail with reference to FIG. 11.

After performing operation S904, when the property prediction request signal including the raw material composition data and the process condition data is received (S906), the processor 240 inputs the raw material composition data and the process condition data to the property prediction model to predict the properties for each process (S908).

When the property prediction request signal including the quality-related data collected in real time is received, the processor 240 may preprocess the quality-related data into the data format for inputting the quality-related data to the property prediction model. Thereafter, the processor 240 may input the preprocessed data to the property prediction module to predict the (semi-finished) product properties (quality) for each process.

When operation S908 is performed, the processor 240 compares the predicted property with the actual property value to evaluate the performance of the property prediction model (S910). In this case, the processor 240 may evaluate the performance of the property prediction model by using the performance evaluation metrics based on the difference between the predicted property and the actual property value.

When operation S910 is performed, the processor 240 determines whether the evaluated performance satisfies the required performance (S912). In other words, the processor 240 may determine whether the evaluated performance is greater than or equal to the preset reference performance.

When the evaluated performance is determined not to satisfy the required performance in operation S912, the processor 240 retrains the property prediction model (S914).

When it is determined by comparing the predicted properties with the product quality and the experimental condition values of the actual production line that the performance is lowered to the set metrics or less, the processor 240 may retrain the property prediction model to resolve the performance degradation of the property prediction model of the manufacturing line.

To retrain the property prediction model, the processor 240 may newly collect the ceramic product quality-related data and regenerate the property prediction model using the collected quality-related data. Through this process, the server 200 for managing quality of a ceramic product may optimally manage/maintain the property prediction model for each process.

After performing operation S904, when the raw material composition/process condition inference request signal including the requested properties is received, the processor 240 may input the user requested properties to the raw material composition/process condition inference model to infer the raw material composition data and process condition data (S918).

When the raw material composition/process condition request signal including the user requested properties is received, the processor 240 may preprocess the requested property data into the data format for inputting the requested property data to the raw material composition/process condition inference model. Thereafter, the processor 240 may input the preprocessed data to the raw material composition/process condition inference model to infer the raw material composition data and the process condition data that satisfy the requested properties.

When operation S918 is performed, the processor 240 compares the inferred raw material composition data and process condition data with the actual value to evaluate the performance of the raw material composition/process condition inference model (S920). The processor 240 may compare the inferred raw material composition data and process condition data with the product quality and the experimental condition values of the actual production line to calculate the accuracy of the raw material composition/process condition inference model.

When operation S920 is performed, the processor 240 determines whether the evaluated performance satisfies the required performance (S922). In other words, the processor 240 may determine whether the evaluated performance is greater than or equal to the preset reference performance.

When the evaluated performance is determined not to satisfy the required performance in operation S922, the processor 240 retrains the raw material composition/process condition inference model (S924).

When it is determined by comparing the inferred raw material composition data and process condition data with the product quality and experimental condition values of the actual production line that the performance is lowered to the set metrics or less, the processor 240 may retrain the raw material composition/process condition inference model to resolve the degradation in the performance of the raw material composition/process condition inference model of the manufacturing line.

To retrain the raw material composition/process condition inference model, the processor 240 may newly collect the ceramic product quality-related data and regenerate the raw material composition/process condition inference model using the collected quality-related data. Through this process, the server 200 for managing quality of a ceramic product may optimally manage/maintain the raw material composition/process condition inference model of the required properties.

FIG. 10 is a flowchart for describing a method of generating a property prediction model according to an embodiment of the present invention.

Referring to FIG. 10, the processor 240 sets the raw material composition data and the process condition data as the input characteristics in the quality-related data, and sets the property data as the output characteristics (S1002).

When operation S1002 is performed, the processor 240 analyzes the correlation between the input characteristics and the output characteristics (S1004), and generates the training data set based on the correlation analysis results (S1006). In this case, the processor 240 may generate, as the training data set, the input characteristics having the correlation coefficient between the input characteristics and the output characteristics that is greater than or equal to a preset value.

When operation S1006 is performed, the processor 240 applies the training data set to each of the plurality of machine learning models to predict the property data (S1008). Here, the machine learning model may be the regression model.

When operation S1008 is performed, the processor 240 evaluates the performance of each machine learning model based on the predicted property data (S1010). That is, the processor 240 may evaluate the performance of each machine learning model using performance evaluation metrics based on the difference between the property data predicted by each machine learning model and the actual property data.

When operation S1010 is performed, the processor 240 selects the optimal machine learning model based on the performance of each machine learning model (S1012). In this case, the processor 240 may select the machine learning model with the best performance as the optimal machine learning model.

When the optimal machine learning model is selected, the processor 240 may repeatedly perform the process of calculating the property prediction performance by applying verification data to the optimal machine learning model, and when the property prediction performance does not satisfy the required performance, regenerating the training data set by modifying the correlation coefficient values of the input characteristics and the output characteristics.

The processor 240 may generate the optimal machine learning model as the property prediction model.

FIG. 11 is a flowchart for describing a method of generating a raw material composition/process condition inference model according to an embodiment of the present invention.

Referring to FIG. 11, the processor 240 may analyze the data distribution characteristics between the property item and the raw material composition data and the process condition data related to the property item (S1102), and generate the training data set based on the data distribution characteristics (S1104). In this case, the processor 240 may analyze the data distribution characteristics between the property item and the raw material composition data and the process condition data related to the property item using Pairplot. When the data distribution characteristics are analyzed, the processor 240 may find and remove outlier data outside a specific range, thereby generating the training data set.

When operation S1104 is performed, the processor 240 applies the training data set to each of the plurality of machine learning models to infer the raw material composition and the process condition data (S1106). Here, the machine learning model may be the classification model.

When operation S1106 is performed, the processor 240 evaluates the performance of each machine learning model based on the inferred raw material composition and process condition data (S1108). In this case, the processor 240 may evaluate the performance of each machine learning model using the accuracy of each machine learning model.

When operation S1108 is performed, the processor 240 selects the optimal machine learning model based on the performance of each machine learning model (S1110). In this case, the processor 240 may select the machine learning model with the best performance (accuracy) as the optimal machine learning model.

When the optimal machine learning model is selected, the processor 240 may repeatedly perform the process of calculating the inference performance by applying the verification data to the optimal machine learning model, and regenerating the training data set when the inference performance does not satisfy the required performance.

The processor 240 may generate the optimal machine learning model as the raw material composition/process condition model.

As described above, according to an aspect of the present invention, by easily applying data collected from four unit processes (ball mill, spray drying, molding, and sintering) of the ceramic manufacturing site to an artificial intelligence model to predict the properties (quality), it is possible to predict defects in the quality of intermediate and final products and identify the causes of the defects, thereby saving time and cost and significantly reducing much trial and error occurring in the inference of the raw material compositions and the process conditions that satisfy the buyer's required properties.

In addition, according to another aspect of the present invention, by introducing the correlation analysis and regression model-based prediction model between data generated in the ceramic manufacturing environment and property (quality) data, it is possible to quickly respond to the degradation in quality and by inferring the raw material compositions and the process conditions that can satisfy the buyer's required properties through the big data-based reverse design AI inference model, it is possible to derive the optimal raw material compositions and process conditions through a small number of trial and error experiments, thereby enabling quick response to the ceramic product market.

Although the present invention has been described with reference to embodiments shown in the accompanying drawings, they are only examples. It will be understood by those skilled in the art that various modifications and equivalent other exemplary embodiments are possible from the present invention.

Therefore, the scope of the present invention is to be defined by the following claims.

What is claimed is:

1. A server for managing quality of a ceramic product, comprising:
a memory;
a communication module; and
a processor connected to the memory and the communication module,
wherein the processor collects quality-related data including at least one of raw material composition data, process condition data, and property data, generates a training data set through correlation analysis between the raw material composition data, the process condition data, and the property data, and generates at least one of a property prediction model and a raw material composition/process condition inference model using the training data set.

2. The server of claim 1, wherein the processor uses the raw material composition data and the process condition data as input characteristics and the property data as output characteristics, generates a training data set through correlation analysis between the input characteristics and the output characteristics, applies the training data set to each of a plurality of machine learning models to predict property data, evaluates performance of each machine learning model based on the predicted property data, selects an optimal machine learning model based on the performance of each machine learning model, and generates the selected optimal machine learning model as the property prediction model.

3. The server of claim 2, wherein the processor generates, as the training data set, input characteristics having a correlation coefficient between the input characteristics and the output characteristics that is greater than or equal to a preset value.

4. The server of claim 2, wherein the processor selects an optimal machine learning model from among the plurality of machine learning models using performance evaluation metrics based on a difference between actual property data and the predicted property data.

5. The server of claim 1, wherein the processor analyzes data distribution characteristics between a property item and raw material composition data and process condition data related to the property item, generates a training data set based on the data distribution characteristics, applies the training data set to each of the plurality of machine learning models to evaluate the performance of each machine learning model, selects an optimal machine learning model based on the performance of each machine learning model, and generates the selected optimal machine learning model as the raw material composition/process condition inference model.

6. The server of claim 5, wherein the processor analyzes the data distribution characteristics between the property item and the raw material composition data and the process condition data related to the property item using Pairplot.

7. The server of claim 1, wherein, when a property prediction request signal including the raw material composition data and the process condition data is received, the processor inputs the raw material composition data and the process condition data to the property prediction model to predict properties for each process.

8. The server of claim 7, wherein the processor compares the predicted property with an actual property value to evaluate the performance of the property prediction model, and retrains the property prediction model when the evaluated performance is less than reference performance.

9. The server of claim 1, wherein, when a raw material composition/process condition inference request signal including a required property is received, the processor inputs the required property to the raw material composition/process condition inference model to infer the raw material composition data and the process condition data.

10. The server of claim 9, wherein the processor compares the inferred raw material composition data and process condition data with an actual value to evaluate the performance of the raw material composition/process condition inference model, and retrains the raw material composition/process condition inference model when the evaluated performance is less than the reference performance.

11. A method of managing quality of a ceramic product, comprising:
collecting, by a processor, quality-related data including at least one of raw material composition data, process condition data, and property data; and
generating, by the processor, a training data set through correlation analysis between the raw material composition data, the process condition data, and the property data, and generating at least one of a property prediction model and a raw material composition/process condition inference model using the training data set.

12. The method of claim 11, wherein, in the generating of the training data set, the raw material composition data and the process condition data are used as input characteristics, the property data is used as output characteristics, a training data set is generated through correlation analysis between the input characteristics and the output characteristics, the training data set is applied to each of a plurality of machine learning models to predict property data, performance of each machine learning model is evaluated based on the predicted property data, an optimal machine learning model is selected based on the performance of each machine learning model, and the selected optimal machine learning model is generated as the property prediction model.

13. The method of claim 12, wherein, in the generating of the training data set, the processor generates, as the training data set, input characteristics having a correlation coefficient between the input characteristics and the output characteristics that is greater than or equal to a preset value.

14. The method of claim 12, wherein, in the generating of the training data set, the processor selects an optimal machine learning model from among the plurality of machine learning models using performance evaluation metrics based on a difference between actual property data and the predicted property data.

15. The method of claim 11, wherein, in the generating of the training data set, the processor analyzes data distribution characteristics between a property item and raw material composition data and process condition data related to the property item, generates the training data set based on the data distribution characteristics, applies the training data set to each of the plurality of machine learning models to evaluate the performance of each machine learning model, selects an optimal machine learning model based on the performance of each machine learning model, and generates the selected optimal machine learning model as the raw material composition/process condition inference model.

16. The method of claim 15, wherein, in the generating of the training data set, the processor analyzes the data distribution characteristics between the property item and the raw material composition data and the process condition data related to the property item using Pairplot.

17. The method of claim 11, further comprising, after the generating of the training data set, when a property prediction request signal including the raw material composition data and the process condition data is received, inputting, by the processor, the raw material composition data and the process condition data to the property prediction model to predict properties for each process.

18. The method of claim 17, further comprising, after the predicting of the properties for each process, comparing the predicted property with an actual property value to evaluate the performance of the property prediction model, and retraining the property prediction model when the evaluated performance is less than reference performance.

19. The method of claim 11, further comprising, after the generating of the training data set, when a raw material composition/process condition inference request signal including a required property is received, inputting, by the processor, the required property to the raw material composition/process condition inference model to infer the raw material composition data and the process condition data.

20. The method of claim 19, further comprising, after inferring the raw material composition data and the process condition data, comparing, by the processor, the inferred raw material composition data and process condition data with an actual value to evaluate performance of the raw material composition/process condition inference model, and retraining the raw material composition/process condition inference model when the evaluated performance is less than reference performance.
